(19) United States
(12) Patent Application Publication
(10) Pub. No.: US 2012/0205877 A1
(43) Pub. Date: Aug. 16, 2012

(54) Gasket

(75) Inventors: Thomas Schumacher, Riederich (DE); Uwe Klump, Dettingen (DE); Oliver Schilli, Gutach (DE)

(73) Assignee: ElringKlinger AG

(21) Appl. No.: 13/136,739

(22) Filed: Aug. 9, 2011

(30) Foreign Application Priority Data
Feb. 12, 2011 (DE) 10 2011 011 103.4

(51) Int. Cl. F02F 11/00; F16J 15/06

(52) U.S. Cl. 277/600; 277/650

(57) ABSTRACT

Gasket, comprising at least one through-opening to be sealed, at least one elastomeric sealing element associated with the through-opening, and a carrier for the sealing element, wherein the sealing element comprises at least one flexible sealing lip enclosing the through-opening in the form of a projection protruding in the direction of the through-opening axis, and embedded in the sealing element is at least one stiff inlay, which projects in the direction of the through-opening axis beyond a carrier area adjacent to the inlay; in order that the sealing element, while in operation, will not be damaged due to high stresses or will not become detached in some areas from the carrier, the inlay surrounds the through-opening in the shape of a ring and without interruption and forms a supporting element which supports the sealing element radially around the through-opening.

The present disclosure relates to the subject matter disclosed in German application number 10 2011 011 103.4 of Feb. 12, 2011, which is incorporated herein by reference in its entirety and for all purposes.

The invention relates to a gasket, in particular, a flat gasket, comprising at least one fluid through-opening to be sealed, the fluid through-opening being adapted for the passage of a fluid under pressure, in particular, a fluid medium, therethrough, at least one elastomeric sealing element associated with the through-opening, and a carrier for the sealing element, wherein the sealing element comprises at least one flexible sealing lip enclosing the through-opening all the way around in the form of a projection protruding in a direction of the through-opening axis beyond an area of the sealing element adjacent to the sealing lip, and wherein embedded in the sealing element is at least one inlay, which is stiff in comparison with the sealing lip and which projects in this direction of the through-opening axis beyond a carrier area adjacent to the inlay.

A similar gasket, which, in particular, is configured as an oil pan gasket for an internal combustion engine, and whose through-opening enclosed by the elastomeric sealing element is a bolt hole for passage of a bolt serving to mount the oil pan, is disclosed in U.S. Pat. No. 6,503,435 B1. In this gasket, there are formed at an inner rim area, enclosing the bolt hole, of the carrier, made of a plastic material by injection molding, small plate-shaped anchoring elements, which are arranged in spaced relation to one another in the circumferential direction of the bolt hole, and are integrally connected to the actual carrier by thin hubs lying in a center plane of the carrier, so that the anchoring elements extend in both directions of the bolt hole axis beyond these hubs, and an undercut is formed on either side of the associated hub between each anchoring element and the actual carrier. An elastomeric sealing element enclosing the bolt hole has in a section taken along a plane containing the bolt hole axis approximately the shape of a narrow rectangle with rounded narrow side areas, with which the sealing element extends beyond the actual carrier in both directions of the bolt hole axis. This sealing element is formed, for example, injection-molded, on the inner rim area of the actual carrier, so that in the finished state it has recesses, which are arranged in spaced relation to one another in the circumferential direction of the bolt hole, are open in the direction towards the actual carrier and are so configured that each of these recesses fittingly receives an anchoring element and the hub holding it, with the crests of the narrow side areas of the sealing element lying almost centrally above or below the anchoring elements. The purpose of this configuration of the sealing element and its anchoring on the carrier is to securely anchor to the carrier a sealing element which is as thin as possible and for which as little of the expensive elastomeric sealing material as possible is required.

When a gasket of the kind defined at the outset is clamped and pressed between sealing surfaces of machine components receiving the gasket between them, too small a spacing of the component sealing surfaces from one another and/or deformations of the machine components occurring, in particular, during operation and/or high pressure peaks occurring in a fluid flowing through the through-opening of the gasket, may lead to high compressive and tensile stresses, possibly also varying locally, within the elastomeric sealing element, more particularly, not only in the area of one or more sealing lips of this sealing element, but also in those areas of the sealing element with which the sealing element is molded to the carrier or connected to the carrier in some other way, for example, adhesively. As a result of these high stresses, the sealing element may, more particularly, also in the area of its sealing lip or its sealing lips, be destroyed and/or become detached at least in some areas from the carrier owing to shear stresses.

In order to avoid or at least minimize at least one of these problems, it is proposed, in accordance with the invention, to so configure a gasket of the kind defined at the outset that the inlay surrounds the through-opening in the shape of a ring and without interruption and forms a supporting element which supports the sealing element radially in relation to the through-opening over the entire circumference of the sealing lip in the area of the sealing lip and/or in the vicinity of the sealing lip. In particular, the supporting element is configured so as to have an equally good supporting effect everywhere along its circumference, preferably owing to the supporting element extending everywhere in the direction of the through-opening axis as far as a plane extending perpendicularly to this axis.

Owing to such a ring-shaped and uninterrupted supporting element, the risk that the elastomeric sealing element will become detached from the carrier, even if only in some areas thereof, but, above all, the risk that the sealing lip will be damaged due to high pressure peaks in the fluid flowing through the through-opening to be sealed, and, again, even if only in some areas thereof, is at least minimized. With a gasket in accordance with the invention, it is, in principle, not a matter of the elastomeric sealing element permanently reliably adhering everywhere to the carrier, also while the gasket is in operation, for after installation of the gasket, the quality of the connection of the carrier to the elastomeric sealing element is at least largely irrelevant for the functioning of the sealing element.

When hereinabove and hereinbelow mention is made of a support in the radial direction in relation to the through-opening, this is to be taken to mean, in the case of a non-circular through-opening, a support in the outward direction (seen from the through-opening). When hereinabove or hereinbelow reference is made to a ring-shaped supporting element without any interruptions, this is not to exclude the supporting element having through-openings such as, for example, holes or slots, the edges of which are spaced from the upper and lower edges of the supporting element in the direction of the through-opening axis.

In a gasket in accordance with the invention, the carrier can be one-part or multipart, because it is only important for the functioning of the elastomeric sealing element, in particular, when the gasket is in operation, that the supporting element supports the elastomeric sealing element without interruption around the through-opening to be sealed in the radial direction in relation to the through-opening.

In preferred embodiments of the gasket in accordance with the invention, the supporting element is of rotationally symmetrical configuration in relation to the through-opening axis, although, seen in the direction of the through-opening axis, it could, for example, also be of polygonal configuration, and the same applies to the shape of the sealing lip.

The supporting element could be embedded in the area of the elastomeric sealing element that forms the sealing lip. However, embodiments are to be preferred, in which the supporting element is arranged radially outwardly of the sealing lip area, but immediately adjacent to the sealing lip area, in relation to the through-opening axis, as there is then an at least substantially homogeneous or equalized stress in the sealing lip area while the gasket is in operation.

The cross section of the supporting element in a section taken along a plane containing the axis of the through-opening to be sealed could, for example, have the shape of a circle, a semicircle, an oval, a rhombus or the like. With regard to manufacture and function of the supporting element, it is, however, preferable for the supporting element to have a web-like cross section, the longitudinal extent of which runs transversely to a plane defined by the carrier or forms an acute angle with this plane.

Since an elastomeric sealing element is usually molded, in particular, injection-molded to a carrier, it is advisable to configure the gasket in accordance with the invention such that the supporting element and preferably also the carrier assume in the closed molding tool the position desired for the configuration of the sealing element and its location with respect to the supporting element, possibly also to the carrier. In order that the molding tool can be constructed as simply as possible, it is recommended that the gasket be so configured that the supporting element—seen in the direction of the through-opening axis—has areas along its circumference, which are not covered by the elastomeric sealing element, and which, in a plan view of the finished gasket, are exposed. The inside wall of the molding tool then only has to be provided with projections which, for correct positioning of the supporting element in the molding tool, bear against these supporting element areas. Expediently, these areas are located at the bottom and/or at the top of the supporting element (provided that the through-opening axis extends vertically).

If the supporting element is connected to the carrier or is formed by an area of the carrier, it is not necessary for an elastomeric sealing element which is to be molded to the supporting element and in which the supporting element is embedded in the finished gasket to be configured such that it also extends into the area of the carrier. In preferred embodiments of the gasket in accordance with the invention, the carrier does, however, have an inner rim area which encloses the through-opening to be sealed and is embedded entirely or in some areas thereof in the sealing element, so that the sealing element can also be molded, in particular, injection-molded, to the carrier.

If a gasket in accordance with the invention has a plurality of sealing lips, which project in both directions of the through-opening axis beyond areas of the elastomeric sealing element adjacent to these sealing lips, it is recommended to configure the supporting element such that it has a supporting effect for all sealing lip areas and/or sealing element areas adjacent to these or to allocate a supporting element to each sealing lip area. In accordance with the invention, at least one supporting element is thus allocated to all sealing lips or to all sealing element areas adjacent to these.

In preferred embodiments of the gasket in accordance with the invention, it is configured as a flat gasket, and use of a substantially flat carrier plate as carrier is then recommended.

The carrier and/or the supporting element could be formed by a plastic part or a plurality of plastic parts. Use of metallic materials for the carrier and/or the supporting element is, however, recommended.

Further advantageous features of the gasket in accordance with the invention will be apparent from the subclaims and/or the appended drawings and also from the following description. In the drawings:

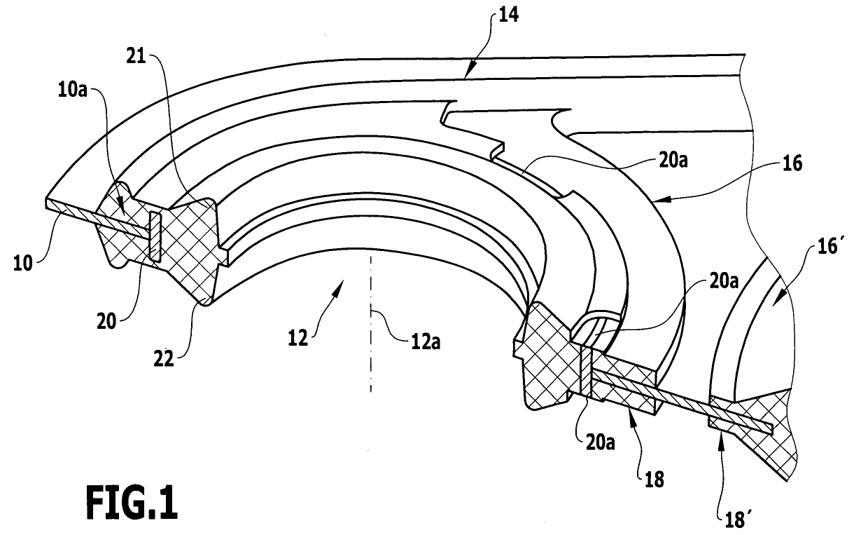

FIG. 1 shows a perspective representation of a cut-open part of a first preferred embodiment of the gasket in accordance with the invention;

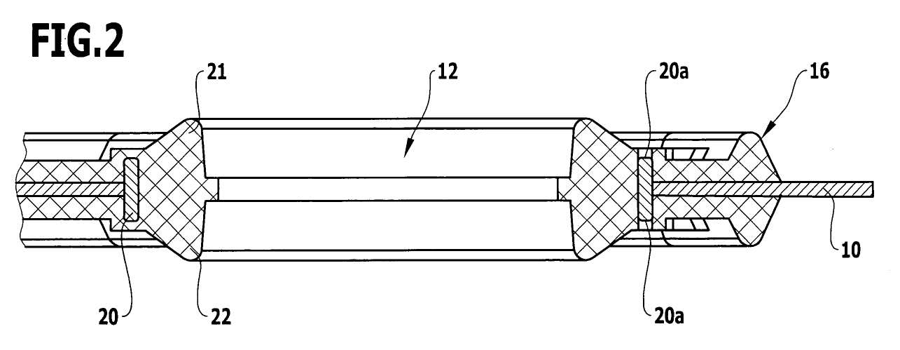

FIG. 2 shows a section through a part of this first embodiment, more particularly, along a plane containing the axis of a through-opening of this gasket that is to be sealed; and

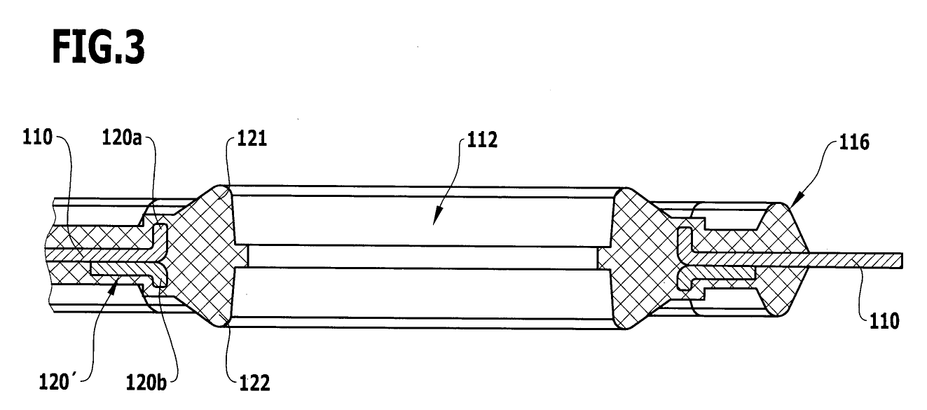

FIGS. 3

to 5 show sectional representations, corresponding to FIG. 2, of a second, third and fourth preferred embodiment of the gasket in accordance with the invention.

The invention is only concerned with that at least one area of a gasket in which a fluid through-opening is located for the passage of a fluid under pressure, as is, above all, the case with a through-opening for oil under pressure, in particular, with a through-opening for hydraulic oil under pressure or for engine oil under pressure. FIG. 1, therefore, shows part of a cylinder head gasket for a reciprocating piston internal combustion engine, where the gasket part shown in the drawing contains as through-opening a so-called pressure oil hole through which engine oil under pressure flows while the engine is in operation. At a fluid through-opening for the passage of a fluid under pressure, completely different conditions prevail during operation than at a fluid through-opening for the passage of an at least almost pressureless fluid, as is the case with a through-opening of a cylinder head gasket for the return flow of the engine oil from the cylinder head to the engine block, but also with an opening of an engine block that is to be closed by an engine oil pan.

The first embodiment, shown only partly in FIG. 1, of a flat gasket in accordance with the invention has a carrier 10 in the form of a flat metallic carrier plate, the thickness of which is preferably only a few tenths of a millimeter, for example, 0.6 mm. The gasket contains at least one through-opening 12, shown only partly in FIG. 1, which is to be sealed all the way around for a fluid that flows through the through-opening during operation, such as, for example, engine oil or hydraulic oil, the gasket being particularly well-suited for cases of use where this fluid is at a pressure that is not constant over time and briefly and repeatedly reaches relatively high peak values. An elastomeric sealing material that is resistant to the fluid to be sealed off was injection-molded onto the carrier 10 in an injection molding tool. This forms an elastomeric profile designated in its entirety 14. An area of this elastomeric profile encloses the through-opening 12 in the form of a ring-shaped sealing element 16. An outer circumferential area of the sealing element 16 forms a holding area 18 in which an inner rim area 10a of the carrier 10 is embedded.

In the illustrated embodiment, the sealing element 16 is configured, in accordance with the invention, mirror-symmetrically in relation to the carrier 10 and forms radially within its holding area 18 an upper and a lower sealing lip 21 and 22, respectively, with an, in particular, approximately triangular cross section, with the sealing lip 21 projecting upwards in the direction of the axis 12a of the through-opening 12 and the sealing lip 22 projecting downwards in the direction of the axis 12a beyond the holding area 18 of the sealing element 16.

FIG. 1 also shows on the right a small part of a further sealing element 16′, formed by the same elastomeric profile 14, with a holding area 18′ in which the carrier 10 is also embedded, the gasket in the area of the sealing element 16′ being configured in accordance with the prior art.

Around the through-opening 12, the gasket has a supporting element 20 embedded in the sealing element 16. The supporting element 20 is made of a sheet metal, which forms a closed ring, and the thickness of which is, in particular, approximately the same as the thickness of the carrier 10. Although not apparent from FIG. 1, the supporting element 20 is to surround the through-opening 12 completely without interruption and is preferably to have the same cross section throughout, so that the supporting element 20 forms a short sleeve in the axial direction, which is preferably configured and arranged coaxially with the axis 12a of the through-opening 12. In the preferred embodiment shown, the supporting element 20 thus has a web-like cross section.

In accordance with the invention, the supporting element 20 bears against the radially inner edge of the carrier 10 or of its inner rim area 10a, so that it is supported in the radial direction outwardly on the carrier 10 when it is subjected to a radially outwardly acting pressure. In the advantageous embodiment shown in FIG. 1, the supporting element 20 can be manufactured as a separate part and does not have to be connected to the carrier 10.

In order that the supporting element 20 will then be held in the desired position in the injection molding tool used when molding the elastomeric profile 14 to the carrier 10, the sealing element 16 does cover the inner rim area 10a of the carrier completely on both sides, but the supporting element 20 only almost completely on both sides—as indicated in FIG. 1, the supporting element 20 comprises, in accordance with the invention, upper and lower edge areas 20a, which are not covered by the elastomeric material of the sealing element 16, i.e., are exposed and are arranged in spaced relation to one another along the circumference of the supporting element 20. When the injection molding tool is closed, these edge areas 20a can be held in exactly the right position between projections provided on its inside wall.

In principle, it would be possible to arrange the supporting element 20 in the area of the sealing lips 21 and 22 (with a corresponding elongation of the inner rim area 10a radially inwardly), so that the supporting element projects into these sealing lips. However, embodiments are preferred, in which the supporting element 20 is arranged radially outwardly of these sealing lips in relation to the axis 12a of the through-opening 12 (still within the sealing element 16, of course), but it is then recommended that the supporting element 20 be positioned immediately adjacent to the sealing lips 21 and 22, as is the case in the embodiment shown in FIG. 1.

FIG. 1 does show a supporting element 20, which projects in both directions of the axis 12a beyond the carrier 10, but, in principle, it is also possible to configure the gasket such that the supporting element projects only in one direction beyond the carrier 10. One of the two sealing lips 21, 22 will then not be supported or at least not as well as the other sealing lip radially outwardly, but the supporting element will still eliminate or at least minimize the risk, while the gasket is in operation, of the sealing element 16 becoming completely detached or even just in some areas from the carrier 10 and/or being damaged owing to excessive compressive and/or tensile stresses, in particular, also in the area of one or both of the sealing lips 21, 22.

The securing of the elastomeric sealing element 16 to the carrier 10 and against damage is, in any case, similar to that of a sealing element in the form of an elastomeric O-ring, which is placed in a groove of a carrier and, in the unpressed state, projects beyond this groove.

FIG. 2 shows the same embodiment as in FIG. 1, more particularly, in a section taken along a plane, along which the gasket shown in FIG. 1 was also cut open. Therefore, an additional description of FIG. 2 can be dispensed with. FIG. 2 does, however, show on the right two exposed edge areas 20a of the supporting element 20, and the recesses in the sealing element 16 are also apparent, owing to which the edge areas 20a are exposed, and which are engaged by the above-described projections of the injection molding tool used for the injection molding of the elastomeric profile 14.

FIGS. 3, 4 and 5 show sectional representations, corresponding to FIG. 2, of a second, third and fourth preferred embodiment of the gasket in accordance with the invention. The reference numerals used in FIGS. 1 and 2, insofar as used in FIGS. 3 to 5, have, however, been increased by 100, 200 and 300, respectively.

In the embodiment shown in FIG. 3, the inner rim area of the carrier 110 was bent upwards, so that it forms a web 120a. Furthermore, this gasket comprises a supporting ring 120′, the inner rim area of which was bent downwards, so that it forms a web 120b. The supporting ring 120′ is preferably fixedly connected to the carrier 110, in particular, by spot welding. It is, however, not absolutely necessary to connect the two parts.

In this embodiment, the two webs 120a and 120b form a supporting element in accordance with the invention, which surrounds the through-opening 112 in the shape of a ring and without interruption.

If in the embodiment shown in FIG. 3 the supporting ring 120′ was fixedly connected to the carrier 110, it is not necessary for the webs 120a, 120b to have edge areas not covered by the elastomeric material of the sealing element 116, and if the supporting ring 120′ was not connected to the carrier 110, areas of the supporting ring 120′ that are not covered by the elastomeric material of the sealing element 116 could be provided at the edge of the web 120b and/or at the bottom end face of the area of the supporting ring 120′ lying radially outwardly of the web 120b.

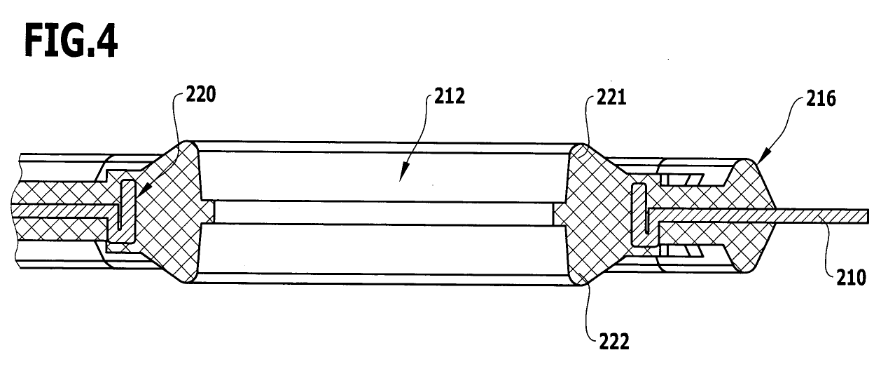

In the embodiment of the gasket in accordance with the invention shown in FIG. 4, an inner rim area of the carrier 210 was shaped, as shown, so as to form a supporting element 220 enclosing the through-opening 212 in the shape of a ring without interruption, which projects in both directions of the axis of the through-opening 212 beyond the carrier 210. For this purpose, the inner rim area of the carrier 210 was shaped in such a way that its cross section forms a U with an upwardly elongated leg.

In this embodiment, it is, in principle, possible to dispense with configuring the sealing element 216 such that the supporting element 220 has areas that are not covered by the elastomeric material of the sealing element. Areas of the carrier 210 and/or of the supporting element 220 that are not covered, may, however, be advantageous if the sheet metal used for the carrier 210 is very thin and, therefore, not particularly dimensionally stable.

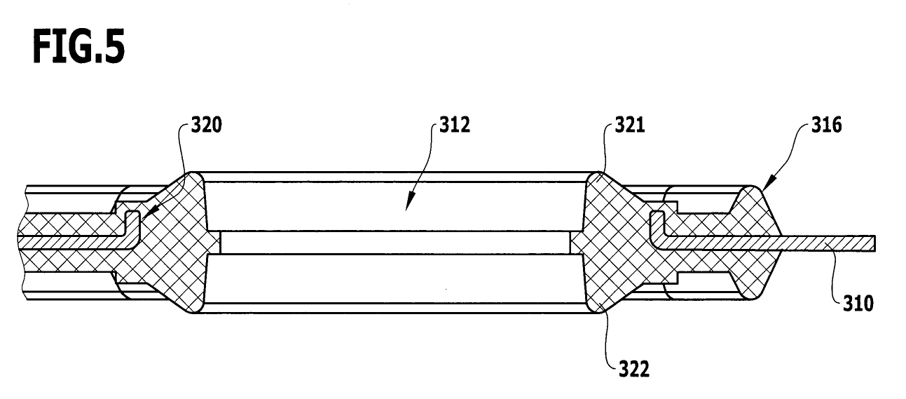

The latter also applies to the embodiment shown in FIG. 5, in which an inner rim area of the carrier 310 was bent only in one direction (upwards in accordance with FIG. 5) to form a supporting element 320. In the case of such an embodiment, it is, in practice, probably recommendable to configure one of the two sealing lips, namely sealing lip 322, flatter, i.e., lower than that sealing lip which points in the same direction as the supporting element 320.

It follows from the foregoing that preferred embodiments of the gasket in accordance with the invention are characterized by the fact that the supporting element supports that area of the elastomeric sealing element radially outwardly in relation to the through-opening which forms the foot of a sealing lip or which is radially outwardly immediately adjacent to the sealing lip foot. Foot of a sealing lip is to be understood as that sealing lip area from which the actual sealing lip extends away from the plane defined by the carrier.

In gaskets in accordance with the invention, in which the supporting element is arranged radially outwardly of the actual sealing lip, more particularly, in a sealing element area radially outwardly adjoining the sealing lip, beyond which the sealing lip projects significantly in the direction of the through-opening axis, the supporting element does not necessarily have to be completely embedded in the elastomeric material of the sealing element (more particularly, also outside of the above-mentioned exposed edge areas). Rather, the supporting element could end in that surface area of the sealing element which extends radially outwardly of the sealing lip, or the supporting element could even project slightly beyond this surface area, even if this is not to be preferred.

In embodiments of the gasket in accordance with the invention, in which the supporting element lies radially outwardly of the actual sealing lip, it is advantageous for the supporting element to extend in the direction of the through-opening axis as far as possible in the direction of the sealing crest of the associated sealing lip, but preferably not beyond that plane which extends perpendicularly to the through-opening axis and also contains the transition of the sealing lip associated with the supporting element to a surface area of the sealing element that adjoins the sealing lip radially outwardly.

1. Gasket, comprising:
at least one fluid through-opening to be sealed, said fluid through-opening having an axis and being adapted for the passage of a fluid under pressure therethrough;
at least one elastomeric sealing element associated with said fluid through-opening; and
a carrier for said sealing element;
wherein said sealing element comprises at least one flexible sealing lip enclosing said through-opening all the way around without interruption in the form of a projection protruding in a direction of said through-opening axis beyond an area of said sealing element adjacent to said sealing lip;
wherein embedded in said sealing element is at least one inlay, which is stiff in comparison with said sealing lip and which projects in this direction of said through-opening axis beyond a carrier area adjacent to said inlay; and
wherein said inlay forms at least one supporting element in the shape of a ring without any interruptions, which supports said sealing element radially outwardly in relation to said through-opening along the entire circumference of said sealing lip in the area of said sealing lip and/or in the vicinity of said sealing lip.

2. Gasket in accordance with claim 1, wherein the supporting element is of rotationally symmetrical configuration in relation to the through-opening axis.

3. Gasket in accordance with claim 1, wherein the supporting element is arranged radially outwardly of the sealing lip, but immediately adjacent thereto, in relation to the through-opening axis.

4. Gasket in accordance with claim 1, wherein the supporting element has a web-like cross section in a section taken along a plane containing the through-opening axis.

5. Gasket in accordance with claim 1, wherein the supporting element, seen in the direction of the through-opening axis, has along its circumference areas not covered by the sealing element, which areas, in a plan view of the gasket, are exposed and are arranged in spaced relation to one another along the circumference of the sealing element.

6. Gasket in accordance with claim 1, wherein the supporting element is formed by a part which is not integral with the carrier.

7. Gasket in accordance with claim 6, wherein the part forming the supporting element is not connected to the carrier.

8. Gasket in accordance with claim 1, wherein the supporting element is formed by an area of the carrier.

9. Gasket in accordance with claim 8, wherein the supporting element is formed by an angled area of the carrier.

10. Gasket in accordance with claim 1, wherein the part forming the supporting element is attached to the carrier.

11. Gasket in accordance with claim 1, wherein the carrier has an inner rim area, which encloses the through-opening and is embedded in the sealing element molded on the carrier.

12. Gasket in accordance with claim 1, wherein a plurality of sealing lips are provided, which project in both directions of the through-opening axis beyond areas of the sealing element adjacent to the sealing lips, and at least one supporting element is provided for all sealing lips.

13. Gasket in accordance with claim 1, wherein the gasket is configured as a flat gasket, and the carrier as a substantially flat carrier plate.

14. Gasket in accordance with claim 1, wherein the carrier and the supporting element are metallic.

15. Gasket in accordance with claim 1, wherein the gasket is configured as a cylinder head gasket.

16. Gasket in accordance with claim 1, wherein the supporting element is embedded at least almost completely in the elastomeric sealing element.

17. Gasket in accordance with claim 1, wherein the gasket, in a plan view thereof, has a ring-shaped gasket area between the through-opening and a crest of the projection of the elastomeric sealing element that forms the sealing lip, and the at least one supporting element is arranged outside of this ring-shaped gasket area, and this gasket area is thus free from the supporting element.

18. Gasket in accordance with claim 17, wherein the ring-shaped gasket area is formed exclusively by the elastomeric sealing element.
